(19) United States
(12) Patent Application Publication
(10) Pub. No.: US 2011/0080002 A1
(43) Pub. Date: Apr. 7, 2011

(54) Controlled momentum hydro-electric system

(75) Inventor: Jose Ramon Santana, Garland, TX (US)

(73) Assignee: Jose Ramon Santana, Garland, TX (US)

(21) Appl. No.: 12/587,231

(22) Filed: Oct. 2, 2009

(51) Int. Cl. F03B 13/08; F03B 17/04

(52) U.S. Cl. 290/54; 415/916

(57) ABSTRACT

A hydroelectric system in which by using a controlled environment within a large container filled with fluids, with means for controlling the dynamic velocity of the complete volume of fluids within the container. This is accomplished by moving the stagnant fluid from a plurality of regions through a plurality of thrust regions where the fluid is discharged to a plurality of regions of the dynamic surface of the same container. The dynamic surface accelerates the complete volume of fluid within the container to proximate the velocity produced by the layers of accelerated fluid from the stagnant regions through the thrust regions. A plurality of waterwheels properly distributed within the container, harvest the kinetic energy within the moving fluids, converting the energy to mechanical energy and transferring the torque created to other components that amplifies the designed revolutions per minutes (RPM) achieved within the container, to a designed RPM for the generation of green electric power. A secondary electrical generating system dependent of the velocity of the drives shafts, supply the electrical current needed for the thrust sources.

### APPLICABLE FIELDS

Hydro-Electric

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT

DISC.—Two copies submitted of the drawings in PDF format to facilitate reproduction without loss of fidelity. This substitute specification includes no new matter in compliance with 37 CFR 121(b)(3) and 1.125.

### BACKGROUND OF THE INVENTION

1. Field of Invention

The present invention relates to a new methodology to harness green energy from water velocities in a controlled environment, designed to reduce the current use of fossil fuel and help improve the quality of the environment, promoting the use of water for the generation of electricity.

Current Solutions to This Problem Are:
A. Hydroelectric plants dependent on the natural flow of river waters, canalizing or damming of river resources
B. Solar Collection Panels
C. Wind Turbine Generators
D. Sea Tidal Water Velocities Turbine Generators
E. Fossil Fuel Power Plants
F. Nuclear Energy

2. Background

Existing hydro-electrical plants produces mechanical energy by directing or channeling moving water. The amount of available energy in moving water is determined by its flow or fall. It carries a great deal of energy in its flow especially if the water is descending rapidly from a very high point. However, the free fall flow technology is limited in the United States to the Niagara Falls because other available river falls are too limited for commercial use, or their use limited by the impact to the fragile ecology of the natural source.

The prevailing systems are the run-of-the-river system, or swiftly flowing water in a big river, creating force applied to propeller blades to spin a generator. The second is the storage system, where water is accumulated in reservoirs created by dams. The current water storage system depends on the controlled release of water volumes through a slopping channel, (the penstock) generating the necessary water velocities until the water reaches the propeller blades to spin a generator. Once the water has turned the turbines generating electricity, the water is released to the river below.

This mechanical motion has limited repetitive cycles since the depletion of the tank can be achieved very quickly in a continuous operation. Its usage is limited to high pick demand periods or periods of high precipitation. However, while effective in an ideal environment; their electrical output are susceptible to instabilities in the water source due to drought, reduction of water flows due to consumption, atmospheric conditions which can destroy or damage the river stations, climatologic changes and availability of water which will limit the utilization of the turbines at the dam. Licensing in any of the systems is rigorous to impossible due to the environmental impact and long term damage.

Despite the advantages of hydroelectric power, the hydroelectric facilities in existence today suffer from a number of drawbacks. With respect to the reservoir-and-dam method of producing electricity from hydropower, the amount of energy extracted from the water depends directly on the difference in height between the source of the water and the water outflow or water head; therefore, not well-suited for areas having a substantially flat geography.

Hydroelectric dams in addition to impacting fish migratory or spawning natural cycles, water releases during electrical production contain temperature differences between the water held in the reservoir and the downstream water flow with lower than normal volumes of dissolved oxygen, impacting negatively biological downstream populations. Because the water exiting the turbine generally contains little suspended sediment, the water tends to scour downstream riverbeds and erode riverbanks. Further, the change in flow rate over the daily cycle of a hydroelectric dam can lead to erosion of sandbars and other downstream structures.

The present invention provides a novel system for producing hydroelectric power incorporating the principles of the operating mechanics of run-of-the-river system and storage system processes, eliminating the limitations existing in both. This is accomplished by moving the process to a controlled environment and creating the necessary conditions for efficient electricity producing systems.

### BRIEF SUMMARY OF THE INVENTION

This green energy hydroelectric plant named the CONTROLLED MOMENTUM HYDRO-ELECTRICAL SYSTEM (COMHES), is a standalone, self-contained, operated under a controlled environment, with flexible configuration for production of electricity at a large or small scale; more particularly, not dependent on natural watercourses or manmade lakes for the controlled released of water volumes through a slopping channel, or river water channeling, for the generation of necessary water velocities for the production of electricity. By removing the variables and unpredictability of Mother Nature associated with natural watercourses and creating an artificial environment, where the water velocities and water head are parametrically designed, allows for the combination of a multiplicity of HKT-Wheels to receive simultaneous impulse force in a correlated field in motion. The COMHES comprises: an enclosed water reservoir, of varied dimensions according to each designed load capacity, of metal or fiber/carbon composite or any other material determined as the interior surface and concrete reinforced construction; containing the necessary water volume for the generation of electricity. The interior floor base will house a plurality of waterwheels/propellers which will harvest the kinetic energy created by the water acceleration by multiple mechanical devices, converting the kinetic energy to mechanical energy. The velocities will be created by water recirculation through centrifugal Turbopumps, essentially forming a venturi. The water velocity will be manually controlled; therefore, the conversion to mechanical energy will be proportional to the determined velocity within the water reservoir and directed toward power generators designed with optimum parameters for power generation. By controlling at will the parameters inside the hydropower generation apparatus, it will allow power generators to be interchangeable among systems of similar capacity.

### DESCRIPTION OF DRAWINGS

The following description of the main component parts and the mechanical explanation of the invention will be made by way of explanation with reference to the accompanying drawings identifying the distinct embodiment of civil, electrical, and mechanical nature constructed or installed in accordance with the teachings of the present invention, distinguished by sequenced letters.

There is a total of Eight Drawings related to this patent application:

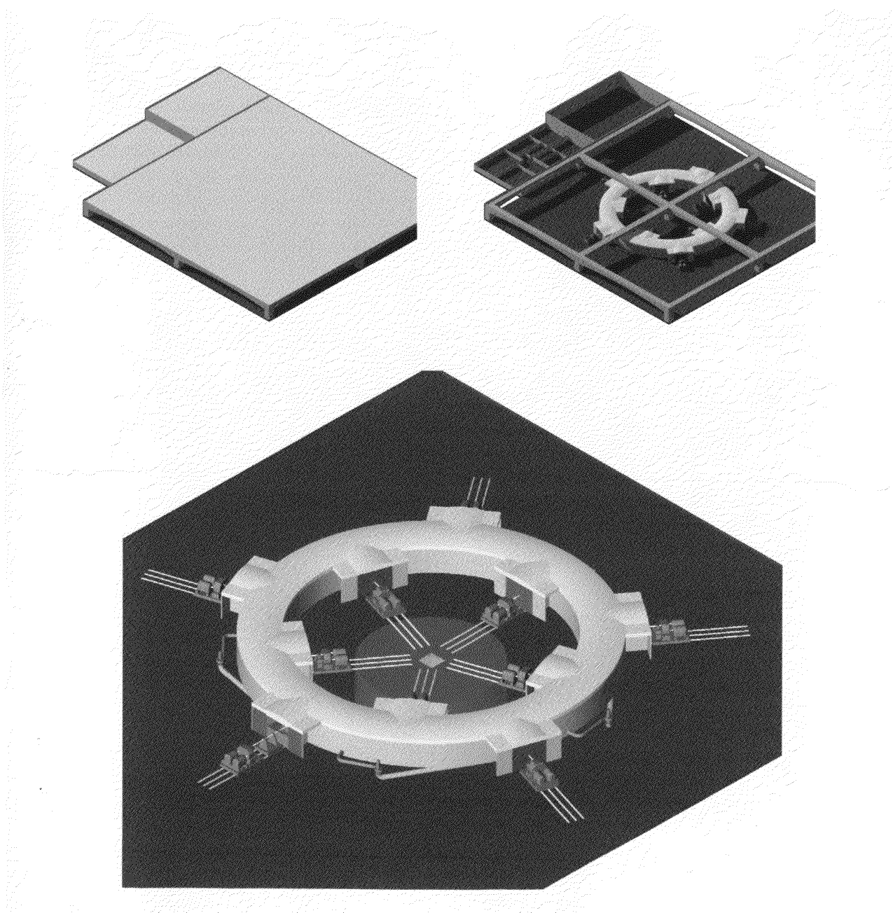

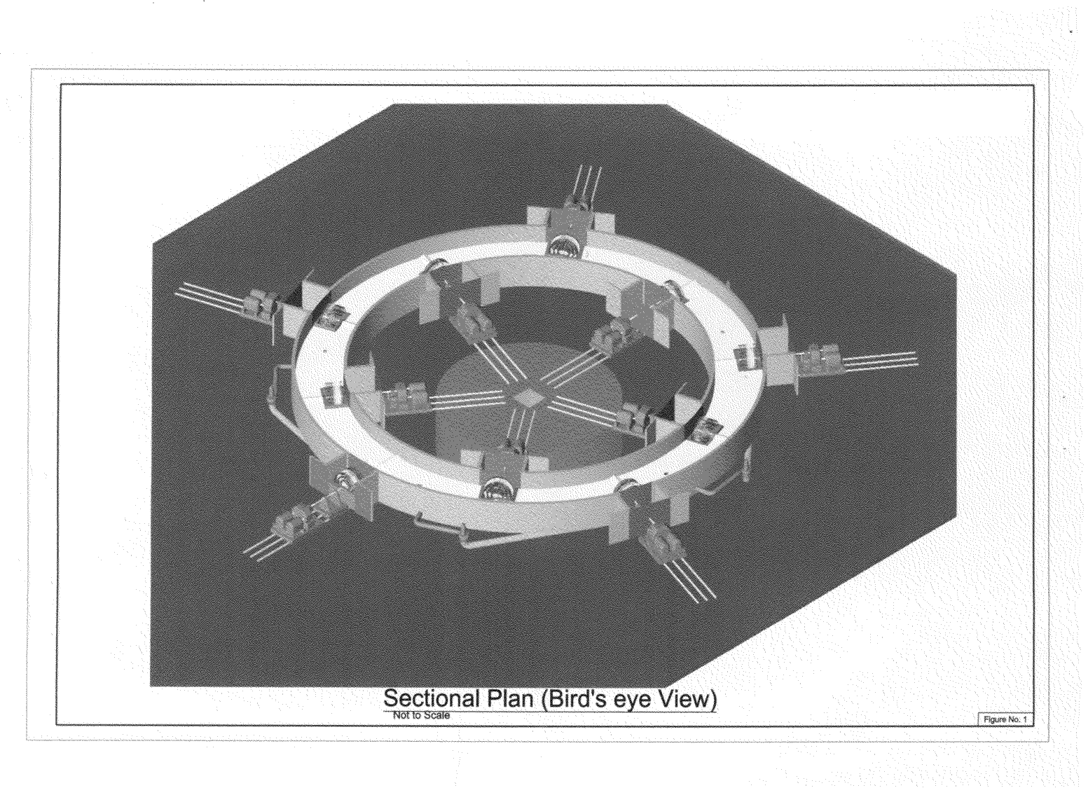

a. FIG. 1 is a full perspective sectional plan view (Bird's eye View) of the invention.

b. FIG. 1A is a Bird's eye View of the completed station.

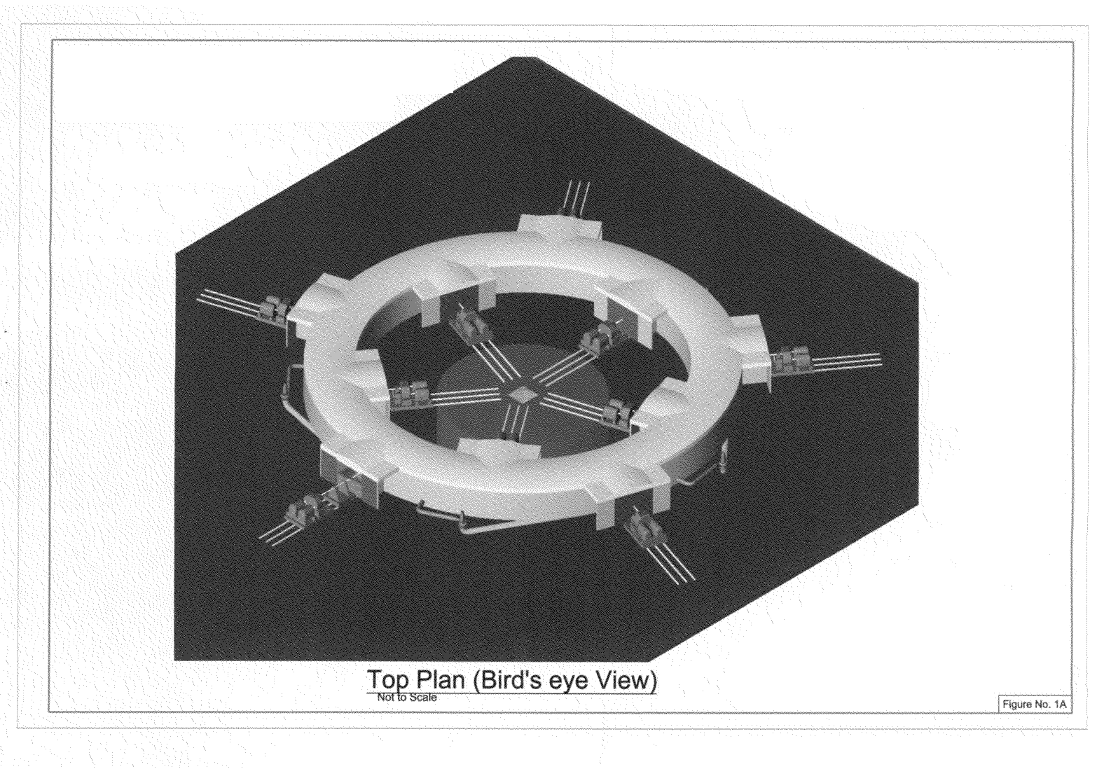

c. FIG. 2 is a perspective plan view of a fully configured operational hydrodynamic plant with all its components.

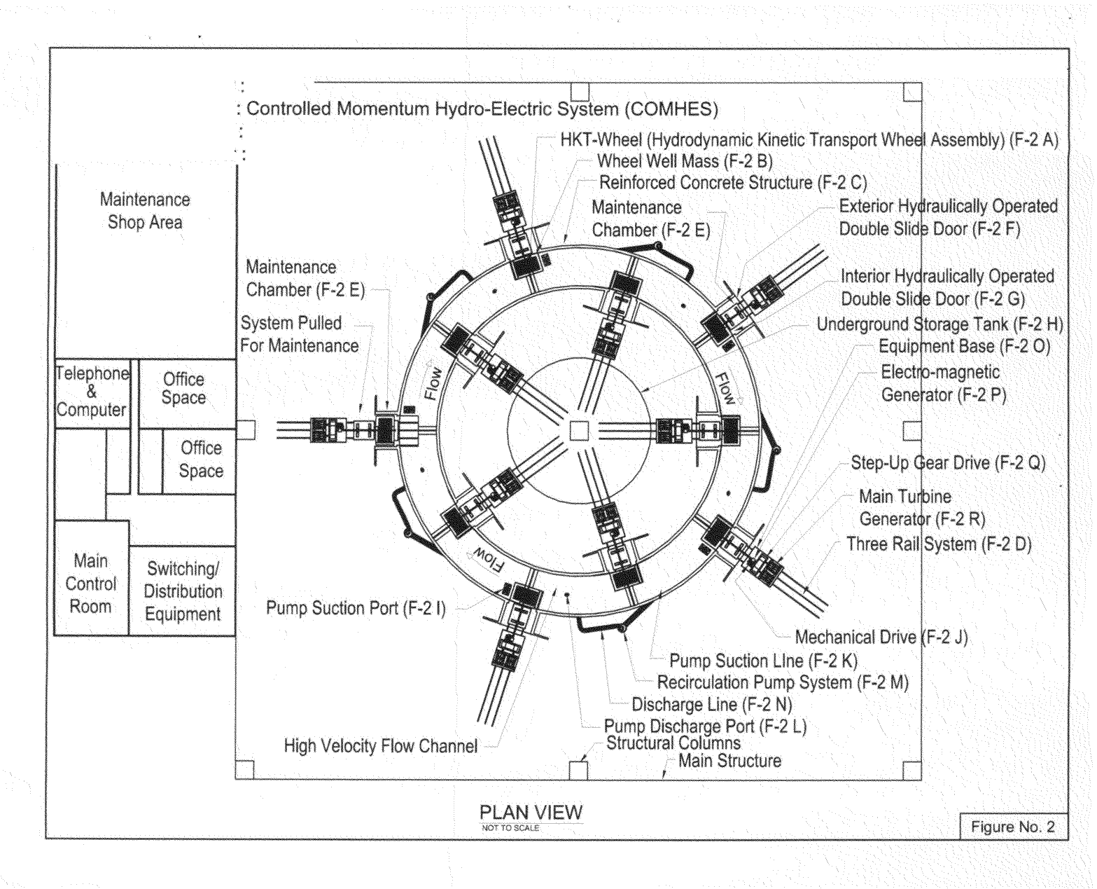

d. FIG. 3 is a typical HKT-Wheel turbine, fully assembled, one of the proposed components of the COMHES.

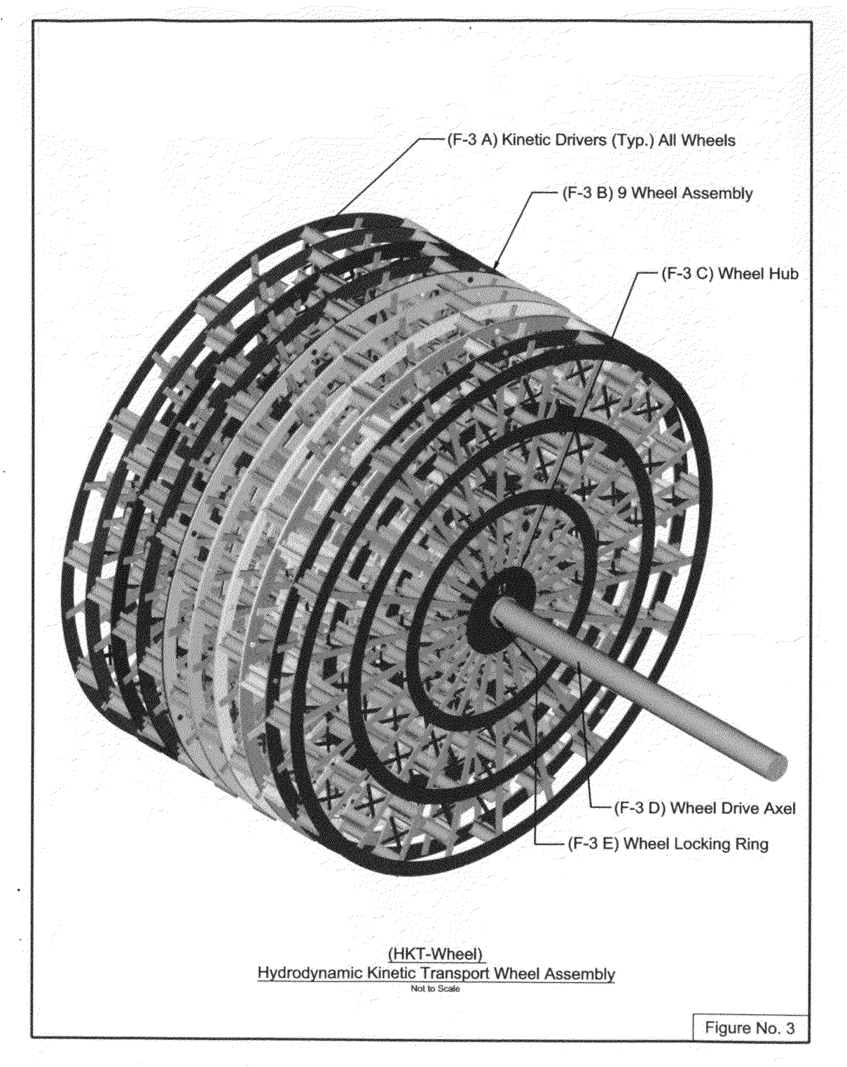

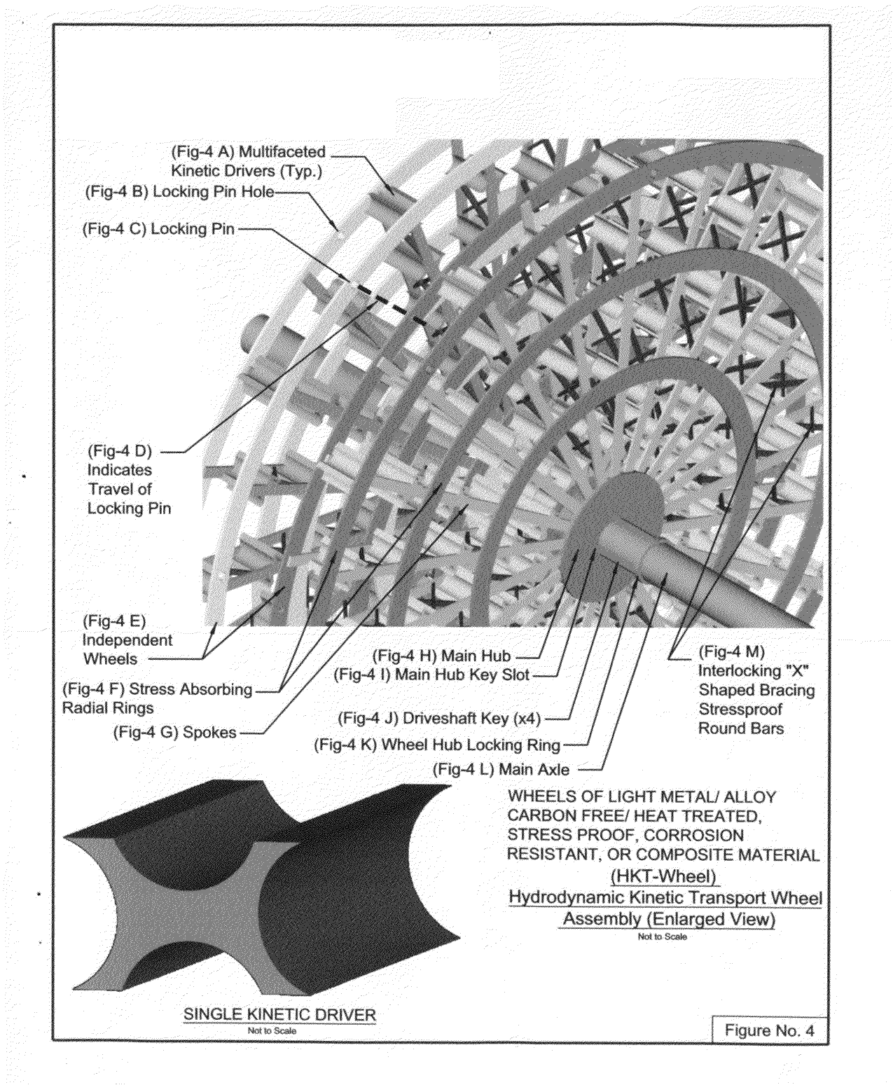

e. FIG. 4 view having portions of a typical HKT-Wheel turbine broken away and enlarged for detail and identification of its components according to the teaching of the invention;

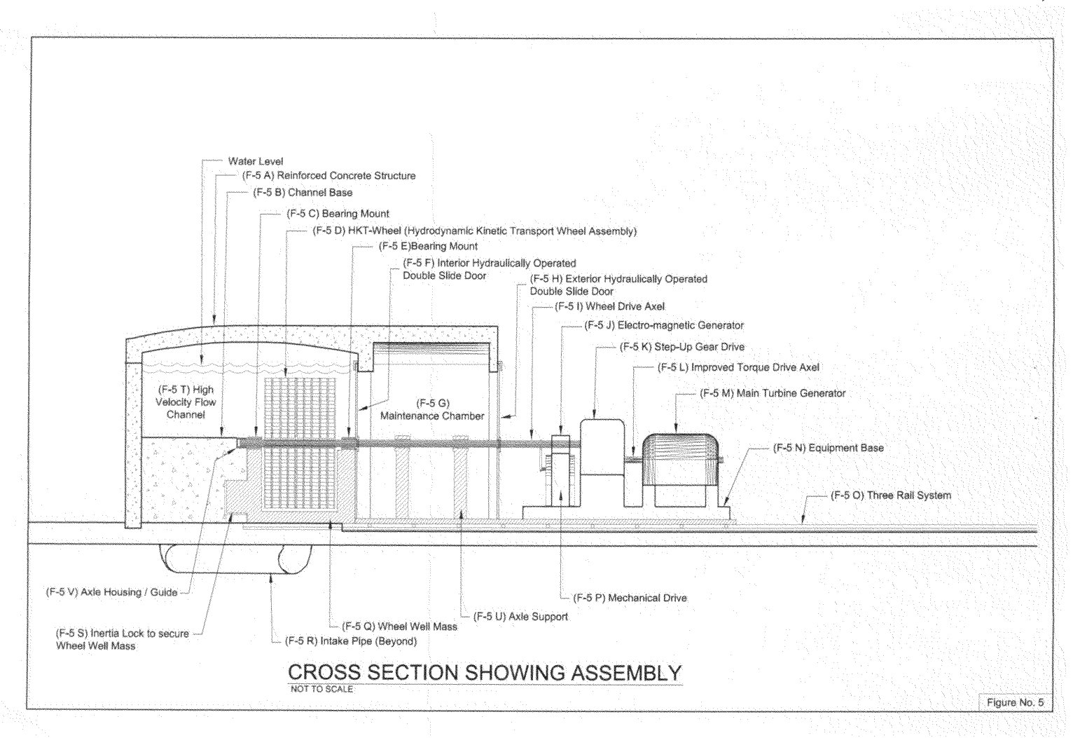

f. FIG. 5 is a cross section view showing the COMHES with all its operational components in an operational hydrodynamic plant.

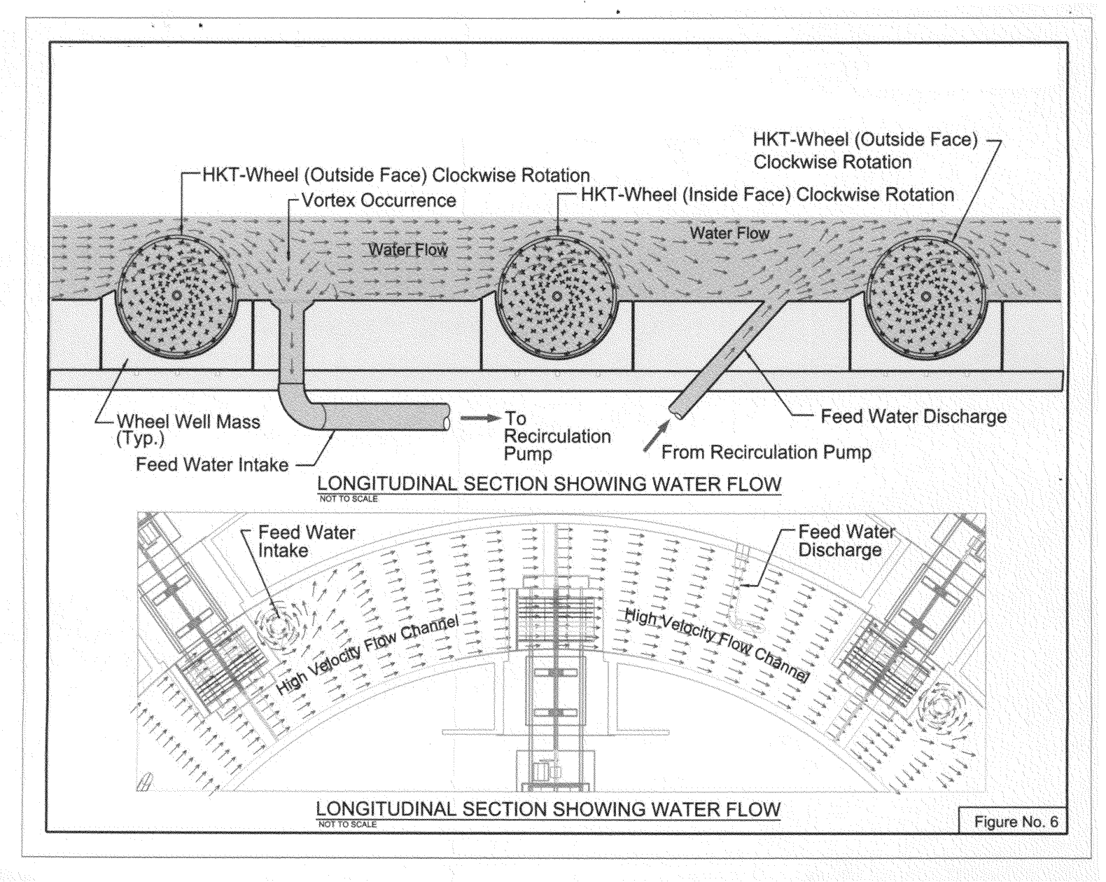

g. FIG. 6 is a longitudinal section showing the water flow through the HKT-Wheel of an application of a typical HKT-Wheel turbine.
h. The Figures illustrated in the cover page present a completed COMHES fully operational under a typical covered environment.

### DETAILED DESCRIPTION OF THE INVENTION

The explanation will follow the drawings, wherein the numbering indentify the drawing number and the sequenced letters, indicates a hydroelectric, mechanical, or component device constructed or installed in accordance with the teachings of the present invention.

The present hydroelectric apparatus is so ecological friendly that can be installed underneath a city, near a natural wildlife reserve or a family park, next to a school, or any other eco-sensitive location. Could be made to totally disappear from sight including the power control equipment, voltage regulators, converters and accumulators without reducing the effectiveness of the system and connected to the city grid with minimum or no overhanging transmission wires. The level of impact to the environment is 00.00%.

FIG. 2 is a perspective plan view of the apparatus constructed in accordance with the teachings of the present invention. The embodiment identified by (F-2 C), represents the interior lining together with an outer layer of concrete structure of the main tank. The lining will provide a rigid, non porous, preferably smooth finished, providing the interior operating surface for the water recirculation. FIG. 1, is a three dimensional rendering providing a better perspective of the components identified in FIG. 2. The cover rendering provides a typical perspective view of the final appearance of the COMHES after the reinforced concrete has been added. The reviewer should be caution that the rendering does not include logical structural variations which will be required to compensate for the dynamic and centrifugal forces to be generated during the normal operation of the COMHES.

The main body of the hydropower generation apparatus, consisting of a of metal or fiber/carbon composite or any other material determined as the interior surface structure, oriented in a circular arrangement, encased in a concrete structure, laid out over an engineered base. This device has been identified as Continuum Dynamics Fluids Tank, herein forward CDFT. The CDFT device will be of different dimensions, consistent with the desired capacity load; to be prefabricated in sections and transported to the site and welded or assembled into the selected place. The chosen thickness will be determined by the designed capacity loads.

The CDFT should be installed after the site has been prepared in accordance with civil engineering requirements, and prepared to withstand tolerance of weight and dynamic stresses of centrifugal forces generated within the CDFT. In addition, the work will include preparation for the installation of motion dampening devices for regions where frequent seismic movement can be expected. This will allow the CDFT to survive, without discernible damage, a level M8 earthquake.

In another aspect of the present invention, within the floor structure of the CDFT, a well wheel mass/cradle devices will be installed to house the turbine waterwheels. The walls of each well wheel mass/cradle device will not be affixed permanently to the structure of the CDFT, and will be moved into place together as a unit with the turbine waterwheels.

The depth portion of the well wheel mass embodiments, FIG. 5 Q, will be determined by the size of the turbine waterwheels which will be in accordance with the designed capacity load. The well wheel mass embodiments will rest at the subfloor level of the CDFT, over a three rail system, lay out diagonally from the CDFT. The cradle will enclose 51% of the propeller/wheel, with a clearance on each side and bottom of the turbine waterwheels consistent with the designed capacity loads. In the current example the clearance is of six (6) inches.

One of the most significant components of the invention is the turbine waterwheels embodiments, with dimensions of depth, width and quantity consistent with designed load factors. Any of various machines in which the kinetic energy of a moving fluid is converted to mechanical power by the impulse or reaction of the fluid can be called in many ways. They are typically called propellers/wheels/waterwheel and turbines. Since the water inside the CDFT of the COMHES will be moving at a steady flow, the transfer of kinetic energy to mechanical power will be at the same rate; therefore, in a correlated homogeneous field. For the purpose of this explanation and for the purpose of this patent application, this unique submersible propeller design, considered an embodiment of the system, will be referred to as the Homogeneous Kinetic Transport Wheel or HKT-Wheel, (F-2 A), FIG. 3, FIGS. 4 and 5 D. Since the HKT-Wheel has multiple applications in others hydrological fields, it is the subject of separate patent application.

According to the invention, the HKT-Wheel, FIG. 3, comprises a plurality of independent wheels of light metal/steel/alloy carbon free/heat treated, corrosion resistant, or composite material. These independent KTT-Wheels will be arrange-able in multiple configurations, including dimensions, length and height.

To avoid confusion as to the subject under explanation due to the interrelated mechanics of the components, the following interpretation should be given:

a. HKT-Wheel=the complete wheel fully assembled with each designed number of interlocking wheels and kinetic drivers.

b. Independent HKT-Wheel=mechanical designed features that allow two or more independent elements to lock each other in a predetermine position, as to become one entity for a designed purpose.

c. Kinetic drivers=cells or drawers shape devices designed to harvest the kinetic energy.

d. Concentric=describes circles and spheres of different sizes with the same middle point, or common axis, or center line.

These independent HKT-Wheels, FIG. 4, will be connected to each other by fixed locking pins, (FIG. 4 C), to matching locking pin holes, (FIG. 4 B), positioned in a plurality of concentric, compression stress absorbing, radial ring body members, (FIG. 4 F).

The number of compression stress absorbing, radial ring body members will be determined by the size of the wheel and the number of rows of kinetic drivers the independent HKT-Wheels will have (FIG. 4 E). Therefore, each independent HKT-Wheel can have from a singularity to multiple radial rings in accordance with capacity designed factors. The Location of each radial ring will indicate the location of the row of kinetic drivers.

The constructions of these independent turbine wheels will be of light metal/steel/alloy carbon free/heat treated, corrosion resistant, or composite material.

Wherein these concentric, compressive stress absorbing, radial ring body members, will be connected by a plurality of spokes, (FIG. 4 G), radiating from the wheel main hub, (FIG. 4 H), traversing through the radial rings to the periphery of the HKT-Wheel, supplying support to the kinetic cells distributed throughout the wheel. These kinetic cells shall be referred herein forward as kinetic drivers.

Wherein a plurality of interlocking X shape, stress-proof, round bars, (FIG. 4 M), will provide lateral support between the spokes. The rigid structured, will be capable of withstanding the extended exposure to the hydrodynamic forces of roll, pitch, jaw and dynamic pressure of the circulating water, transferring all stresses toward the core and center of the wheel.

Wherein each independent wheel has a common axis of rotation and common main axle drive, (FIG. 4 L).

Wherein these independent wheels are locked into the main shaft as the wheel is slipped through a plurality of hub key slot designed into the wheel, (FIG. 4 I), into a plurality of driveshaft key designed into the shaft, (FIG. 4 J), held in place by wheel hub locking rings positioned at each end of the wheels, (FIG. 4 K).

Wherein the conventional waterwheel is a two-dimensional water-foil, most are of run of the river systems, of solid construction and limited to 45 degrees of radial performance. In the case of the Pelton Wheel, nozzles direct forceful streams of water against a series of spoon-shaped buckets mounted around the edge of a wheel. As water flows into the bucket, the direction of the water velocity changes to follow the contour of the bucket. When the water-jet contacts the bucket, the water exerts pressure on the bucket and the water is decelerated as it does a “u-turn” and flows out the other side of the bucket at low velocity. In the process, the water's momentum is transferred to the turbine. However, the performance of the buckets is limited to the water jet impact in the peripheral area.

Wherein the HKT-Wheel according to the invention, the harvesting of the kinetic energy will be substantially increased by using the full periphery of the 180 degree of the waterwheel incident flow and allowing the water to flow through the waterwheel and distribute the water pressure over the plurality of multifaceted kinetic drivers.

Wherein these independent HKT-Wheels carrying one or more multifaceted, open ended, kinetic drivers, FIG. 4, with a designed space between each other, wherein the designed space between the multifaceted kinetic drivers is maintained vertically and horizontally. This is achieved by changing the location of the kinetic drivers in the second and subsequent rows, in relationship with the kinetic driver immediately in front so as to be offset one half of its length. Mentioned offset will allow locating the kinetic driver following in the next row, in the middle of the space opening between the two kinetic drivers immediately in front. This relationship can be observed if reviewed in FIG. 3 and FIG. 4 by observing the offsetting of the kinetic drivers in two adjacent HKT-Wheels.

Wherein these multifaceted kinetic drivers are distributed wall-to-wall occupying the peripheral annulus of the water stream, if observed from an angle paralleled to the flow of rotation, the second and subsequent rows of kinetic drivers are placed in the open space of the row in front, eliminating all dead interstitial segments which could limit the transportable water volumes, or where kinetic drivers are not located. This designed increases exponentially the torque created by the efficiency of the kinetic energy recovered in the water stream by the higher number of kinetic drivers added on each ream in the radial direction, perpendicular to the water flow. Higher kinetic drivers in the radial direction mean a greater reduction of the needed head without the loss of potentially recoverable kinetic energy.

A significant attribute of the kinetic drivers is the different capabilities available according to the amount of torque needed to achieve design electric output production parameters. A larger separation will allow for larger size of the wheel requiring larger torque. A larger separation will prevent the increase of drag allowing better water flow though the wheel. The same purpose will be achieved by reducing the water head and reducing proportionally the separation of the kinetic drivers.

Contrary to traditional waterwheel designs which requires a closed cell to achieve maximum efficiency, in the KTT-Wheel completely closed cells will be detrimental creating unwanted drag restricting the rotational path. However, due to the design, a new kinetic driver side within the same fixed location engages the water flow, imparting a continued reaction impulse to the waterwheel, making a substantial contribution to the total torque. The high efficiency of the illustrated KTT-Wheel in exploiting the potential energy of the watercourse is appreciably supplemented by additionally utilizing the impulse energy of the water as it enters and leaves the waterwheel. Of decisive importance for this is that the entrance and exits points of the water can be precisely controlled as the wheel rotates. This can only be done with cells that are opened.

The invention exploits the normal properties of water, consistent with Bernoulli's principle which concluded that, pressure and velocity are inversely related, in other words, as one increases, the other decreases; and states that for all changes in movement, the sum of static and dynamic pressure in a fluid remains the same. Due to the Venturi effect in the reduction in fluid pressure that will result as the water flow is constricted by the reduced space between the kinetic drivers, the fluid velocity will increase to satisfy the equation of continuity, while the water pressure will decrease due to the conservation of energy, the gain in kinetic energy will be balanced by the drop in pressure or pressure gradient force.

Wherein common waterwheels designs avoid the natural behavior of fluids while immerse, or the form drag. The form of an object in fluids mechanics is defined by its shape. The shape of an object located in some space is the part of that space occupied by the object, as determined by its external boundary abstracting from other properties such as material composition, as well as from the object's other spatial properties, such as position and orientation in space. Therefore, the fixed location and angle of the cell within the waterwheel, as it traverse the orbital rotation axis, becomes engaged in the opposite direction of the water flow, creating a form drag of opposite force over the axle, at which point the performance began to decay. We shall refer to this spatial moment as the point in the waterwheel where the cell becomes a retreating blade.

In hydrodynamics, angle of attack is used to describe the angle between the chord line and the vector representing the relative motion between the wheel and the water flow. In a typical aerodynamic scenario a wing can have twists, a chord line of the whole wing may not be definable; however, do to the rigidity of the structure of the wheel; a defined line can be used. The chord line of the wheel is chosen as the reference line.

In the HKT-Wheel the effects of the retrieving blade are neutralized by the well wheel mass (F-5 Q), equally to one half the heights in the design of the wheel, which can be located above or below the wheel. The well wheel mass will be separated from the wheel by different space separation consistent with design capacity factors. In the illustrated example the separation is of just six inches from the wheel. The design will allow the blade to transfer the kinetic energy from the water to the wheel shaft in the 180 degrees effective of the orbital wheel position.

The HKT-Wheel will de-load as it enters the well wheel mass embodiments without the water creating undue friction or pressure on the wheel as the kinetic drivers move from the point of retreating blade, into position of angle of attack to start again the cycle. FIGS. 5 and 6 provides a better understanding of the explanation. While FIG. 6 will be the subject of further discussion below, it illustrate the flow of water through the wheel and FIG. 4 provides a closer view of the positioning of the kinetic drivers and actual multifaceted shape.

In order to secure the HKT-Wheel, it will be accomplished by another aspect of the present invention, the main shaft(s), Figure (F-3 D) and (F-4 L).

In another aspect of the present invention, two bearing mounts anchoring devices, structurally designed and positioned on each side of the well wheel mass/cradle device, will hold the main shaft in place (F-5 C, F-5 E).

The floor base of the water circulating within the CDFT shall be identified as the channel base level, (F-5 B).

The invention anticipates that the well wheel mass/cradle device, the main shaft and the HKT-Wheel will move over a rail system installed into the floor of the concrete structure, FIG. 1, F-2 D) (F-5 O). The rail system has multiple applications in the operation of the COMHES. It is conceived that all the operational devices will be mounted in rail car platforms. The principle of installing the embodiment of each power generating unit in a rail platform, provides flexibility of operation. If for any reason a complete unit needs to be replaced, or any other of the component devices, another embodiment can be moved into position within a short period, by pulling all the cars where the equipment is sequentially installed, or by moving the platforms to another track, and moving a new set into place with relatively short downtime.

The center of each well wheel mass/cradle device will follow the center of the HKT-Wheel, which will be defined by the HKT-Wheel main shaft(s), of special designed, on which the HKT-Wheel is driven by the water velocity and collects the kinetic energy and transfers the mechanical energy to the generators.

To facilitate the installation and removal of the wheel well mass/cradle device, together with the turbine waterwheels and shaft, another aspect of the invention, a fixed axel guide (F-5 V), a tube device, installed imbedded into the concrete structure, below the channel base level of the CDFT. The fixed axel guide will be designed to hold in place the shaft and to help support the weight load of the propeller/wheel and shaft during the extreme dynamic forces exerted by the weight and velocity of the rotating water. The fixed axel guide will include in the designed, a series of bearings, allowing for the ease insertion of the shaft and free rotation of the shaft during operation.

As the wheel well mass/cradle device, turbine waterwheels and shaft are positioned into the CDFT, the three rails will properly aligned the devices into the CDFT while the fixed axel guide will ensure the perpendicular alignment of the shaft. This will position the HKT-Wheel 51% below the circulating water, and the wheel well mass/cradle device will render the bottom half of the HKT-Wheel ineffective. The reason for this condition will be explained further. The wheel well mass/cradle device will be secured within the CDFT by inertia locking devices, (F-5 S).

It is contemplated that the COMHES will have access openings on the side of the CDFT for each power generating embodiment, of sufficient size that will allow the removal of the HKT-Wheel for maintenance and repairs.

At each location of the propellers access openings, metal doors will be installed, (F-2 F and F-2 G) and (F-5 F, F-5 H) capable of safely operating under the normal internal pressure of the tank and large enough to allow for the installation and removal of the HKT-Wheel. The doors will be encased in a metal frame and the frame permanently attached to the CDFT. The doors will be designed to open laterally along the frame, equipped with roller bearing, facilitating the movement of the heavy doors. The doors will open electronically by electrical, pneumatic or mechanical means. These doors will be watertight by pressure exerted against each door equipped with rubberized male-female edges, and encircling the main shaft through a special housing around the main shaft bearing mount (F-5 E). The special designed steel doors, integral part of the structure of the CDFT, will allow access to the KTT-Wheel to be removed from operation for maintenance, repairs or replacement, without stopping the operating circulating water.

The doors when opened will retrieve inside a metal box that will house the doors. The metal boxes will facilitate the movement of the doors providing a bearing equipped support edge and will prevent the doors from damage while opened. This metal box will be attached to the CDFT.

Over the inside edge of the doors metal box, a metal maintenance chamber/vault will be attached, F-5 G). The maintenance chamber/vault will be large enough to hold the HKT-Wheel after it had been retrieved from operation, consistent with maintenance requirements and without the need of interrupting the operational movement of the water inside the tank. This maintenance chamber/vault will be watertight and in the outer wall a duplicate door, similar to the one previously described, will be installed. The maintenance chamber/vault will be reinforced as previously indicated for the CDFT.

Outside the metal maintenance chamber/vault, as an added auxiliary device designed to use the rotation of the main shaft as the main drive source, it is envisioned the installation of an electromagnetic generator (F-2 P) and (F-5 J), to power primary and secondary equipment of the COMHES, primarily, the Centrifugal Turbopump(s) of the embodiment.

It is envisioned the use of the most advanced fluid flow control equipment available. Available data suggest that five Centrifugal Turbopumps (CTP) (F-2 M and FIG. 1A), will be capable of providing the necessary water velocities needed inside the CDFT for the efficient operation of the system. Currently available in the market are CTPs with the capacity of moving no less than 200,000 gallon per minute (GPM) of circulation, up to five atmospheres (5,000 psi) of pressure. A centrifugal pump works by the conversion of the rotational kinetic energy. In the COMHES electric pump will be used, to increase static fluid pressure. This action is described by Bernoulli's principle. The rotation of the pump impeller imparts kinetic energy to the fluid as it is drawn in from the impeller eye (centre) and is forced outward through the impeller vanes to the periphery. As the fluid exits the impeller, the fluid kinetic energy (velocity) is then converted to (static) pressure due to the change in area the fluid experiences in the volute section. Typically the volute shape of the pump casing (increasing in volume), or the diffuser vanes (which serve to slow the fluid, converting to kinetic energy in to flow work) are responsible for the energy conversion. The energy conversion results in an increased pressure on the downstream side of the pump, causing flow. A principal advantage of hydraulic power is the high power density (power per unit weight) that can be achieved. They also provide a fixed displacement per revolution and, within mechanical limitations, infinite pressure to move fluids.

Due to the inability to resist deformation, fluids exert pressure normal any contacting surface. In addition, when the fluid is at rest, that pressure is isotropic, i.e. it acts with equal magnitude in all directions. This characteristic allows fluids to transmit force through the length of pipes or tubes, i.e., a force applied to a fluid in a pipe are transmitted, via the fluid, to the other end of the pipe. Considering a small cube of liquid at rest below a free surface, pressure caused by the height of the liquid above must be balanced by a resisting pressure in this small cube. For an infinitely small cube, or defined like in the instance case of the COMHES, the stress is the same in all directions and liquid weight or equivalent pressure will be equal along the CDFT. The fact that the water in the CDFT is placed in motion by exerting velocity at different sections of the tank, since no outside agent is introduced, except the force to place to the water into motion, the increase in pressure should be negligible. However, as the fluid exits the impeller of the TP, the fluid kinetic energy (velocity) is then converted to (static) pressure due to the change in area the fluid experiences in the volute section. As the water molecules are accelerated, air bubbles will form increasing the air pressure inside the tank necessitating pressure release valves to compensate for the buildup.

The needed dynamic head will be achieved by activating all five CTPs at the same time. Initially, since the stagnant water will resist developing motion (momentum law), the pressure will build on the intake side of the pump as 1,000,000 gallons per minute circulation motion establishes water movement. This apparent deflection of the moving water when observed from a rotating reference frame, the Coriolis force appears, along with the centrifugal force (FIG. 6). The Coriolis force is proportional to the speed of rotation and the centrifugal force is proportional to its square. The Coriolis force acts in a direction perpendicular to the rotation axis and to the velocity of the body in the rotating frame and is proportional to the object's speed in the rotating frame. The centrifugal force acts outwards in the radial direction and is proportional to the distance of the body from the axis of the rotating frame. However, these forces will vanish in an inertial frame of reference.

To quantify the effect of the impulse impacted by the CTP to the stagnant water inside the tank, we looked at related data of completed studies. The data found establishing the velocity correlation of length and time on the initial particle velocity, was of studies on straight line models. The velocity correlation length was found to increase with the initial particle velocity, following the momentum law. Such effect is likely to be found on circular models as well due to the channeling of high-velocity zones. The results demonstrated that particles keep memory of their initial velocity over longer distances for high initial velocities than for low initial velocities. Two distinct regimes were identified for the velocity correlation time. For low initial particle velocities the correlation time is controlled by the large time needed to escape from the low-velocity zones. For high initial particle velocity it is controlled by the large time needed for particles to sample the whole velocity field, in particular low-velocity zones. One of the consequences of these results is that for such velocity fields, the nonlinear dependence of both the correlation length and time on the particle initial velocity, restricts the use of spatial or temporal assumptions for modeling velocity transitions; therefore, ineffective in circular transport models.

The HKT-Wheel will be activated the moment the water is placed into motion. When all the time derivatives of a flow field vanish, the flow will be considered to be at the designed flow.

Significant computational analysis has been made in regards to the hydrodynamic events that should be expected due to the known behavioral propensity of water under different velocities, being some of these, vortex formation, vortex-induced resonance and vortex shedding.

Since real fluids always present some viscosity (thickness), viscosity describes a fluid's internal resistance to flow and may be thought of as a measure of fluid friction. It should be expected that the water flow around the kinetic drivers will be slowed down while in contact with its surface, forming the so called boundary layer. At some point, however, this boundary layer can separate from the body forming vortices changing the pressure distribution along the surface. When the vortices are not formed symmetrically around the body (with respect to its mid-plane), different lift forces develop on each side of the body, thus leading to motion transverse to the flow. This motion changes the nature of the vortex formation in such a way as to lead to limited motion amplitude.

Vortex shedding are the most typical to be found in the proposed operation of the invention, which is an unsteady flow that takes place in special flow velocities. Vortex shedding is caused when a fluid flows past the object creating alternating low-pressure vortices on the downstream side of the object. The object will tend to move toward to the low pressure zone. Eventually, if the frequency of vortex shedding matches the resonance frequency of the structure, the structure will begin to resonate and the structure's movement can become self-sustaining.

The possibility of this condition has been eliminated by locating the pumps intakes at a distance to be designated by design (FIG. 6), from for the retrieving blade end of the HKT-Wheels. The intake will be in the floor of the CDFT with an aperture of approximately of five feet in diameter. The water velocity of the intake will create a low pressure below the HKT-Wheels due to the suction of the pump impeller.

The velocity of the water outside the rotating frame will dissipate any possible vortices formation within the KTT-Wheels and will serve to provide additional torque by also engaging the kinetic drivers of the retreating blades from a vertical direction in forty five degrees perpendicular to the axis, (FIG. 6). Concurrently, this movement will dissipate any possible resonance because it is unlikely that the concrete floor can vibrate harmonically with the metal frame of the KTT-Wheel.

In the COMHES, the discharge point has been designed to be parallel to the flow of water, FIG. 6, in the middle of the stream of the circulating flow between the next second and third KTT-Wheels. The increased static pressure due to the change in area the fluid experiences in the volute section will increase the pressure on the downstream side of the pump. As it converges with the water flow, the increased velocity is dispersed in a conical shape, expanding in all directions until it reaches the internal walls, creating a new spatial velocity frame. This higher kinetic energy into the water flow will be responsible for the energy conversion velocity of the next two KTT-Wheels. Therefore, one set of pumps provide the necessary water head speed for the operation of two HKT-Wheels.

The rest of the explanation continues with the rest of the components of the COMHES. Attached to the main driveshaft, a step-up gear system, (F-2 Q) and (F-5 K) will be installed. FIG. 1 provides a tridimensional view of the step-up gears.

Currently in operation, step-gears designed for wind turbine generators with an input shaft speed, rpm of 47, 32 can achieve an out shaft speed of 1,500 rpm. The factors are expected to be improved with the COMHES principle, do to consistencies on input shaft speed and reliable water velocities inside the CDFT.

Conventional hydroelectric turbines are very effective when they turn at their speed of design under a determined water head, and under design load. Their effectiveness falls quickly when moved away from one or more of these 3 conditions. Each conventional turbine is designed and built specifically for a dam according to these 3 conditions, and it cannot be inter-changed with other hydroelectric power stations. In the COMHES, since the speed of the water is determined by choice and the water head predetermined within the tank, precise load factors can be predicted for final wheel design, which will determine the final load factors for the turbines. Therefore, each turbine can be designed with maximum efficiency and interchangeable between each system of similar capacity load.

Connected to the output driveshaft of the step-up gear, there will be the power turbine generators (F-2 R) and (F-5 M)) with a rated capacity according to the EMHES design. Since minimum down time is anticipated, for planning purposes, a conservative model of a 90% capacity factor is expected.

Conceptually represented in FIG. 1 and Figure F2-Q, the step-up gears divide the input shaft speed into two operational generators (F-2 R). Preliminaries studies suggest that, since the water speed inside the CDFT can be increased or decreased at will, by design parameters, the main drive shaft will be able to drive a series of multiple step-up gears increasing exponentially the generating capacity.

The next embodiment of the EMHES is a reserve holding tank, illustrated in FIG. 1 in the center of the structure, to replenish the water that through friction and evaporation could be lost. The location of the tank will be underground, with connecting lines to the CDFT which will maintain the operational water level and to each of maintenance chambers/vault for filling and dewatering during the maintenance of the KTT-Wheels.

The dewatering of the tank should it become necessary; can be accomplished through proper designed underground outlets, or permeable retention ponds, or underground porous layers which could absorbed an emergency dewatering.

There are several significant components associated with electrical distribution, ancillary devices, monitoring, security which will be irrelevant to mention because are germane to the existing generating plants and will be used in the COMHES, but all devices and components to be used will have 0% impact to the environment.

It is envisioned that a structural designed building will house the COMHES, maintenance, distribution equipment, and staff; illustrations in the cover page and FIG. 2. This structure when in place will be a supply source for recoverable water by incorporating in the design ways to maximize the collection and storage of rain water for the operation of the CDFT or other means of channeling and collecting rain water. Additionally, the water for the operation of the CDFT can be obtained from the recycling of water from sewer treatment plans with environmental friendly chemicals. The amount of water needed for operation of the COMHES will vary according to designed capacity. However, the system does not need potable water as long as is free from sediments and debris. There are so many ways to secure the necessary volume of water needed for operation that the proliferation in the use of the COMHES will not represent a competition for available resources designed for population, industrial and agricultural needs.

Many limitations exist in the presentation of an invention since the laws tends to restricts rather than anticipate possible improvements and deviations from a concept. The present invention has been illustrated by the description of exemplary processes and system components, and while the various processes and components have been described in considerable detail, it has not being the intention of the applicant in any way to limit the scope of the appended claims to such details as to preclude any additional advantages and modifications which may also readily appear to those ordinarily skilled in the art. The invention in its broadest aspects is therefore, not limited to the specific details, implementations, or illustrative examples shown and described. Accordingly, departures may be made from such details without departing from the spirit or scope of applicant's general inventive concept.

### Maintenance Repairs or Replacement of the HKT-Wheel

When it becomes necessary to perform maintenance to the HKT-Wheel, the vault will be flooded with water from the reserve tank. When the pressure inside the maintenance chamber and the CDFT is equalized, the inside door of the CDFT, next to the wheel, will be opened. Without changing the operating conditions inside the CDFT, the wheel will be pulled by activating a device which will pull the complete system from the wheel, the wheel well mass to the generator, away from the CDFT until the HKT-Wheel is safely inside the vault.

Once safely inside the maintenance chamber and out of the water flow, the HKT-Wheel will slow down its rotation and the doors will be closed. After the wheel has stopped turning, the maintenance chamber will be dewatered and the water returned to the holding tank.

FIG. 1 provides a better view of the overall configuration arrangement of the maintenance chamber with an illustration on the left hand side, of a HKT-Wheel that has been retrieved from operations for maintenance.

The second door of the vault can be opened and the HKT-Wheel removed together with the complete set of operating accompanying equipment.

After the intended maintenance purpose has been completed, the reverse procedure is executed. The only action which should be carefully performed is to ease the wheel slowly into the water flow, allowing operational rotation without exposing the wheel to high dynamic force affecting other components of the system.

It is claimed:

1. A hydroelectric system in which by using a controlled environment within a large container filled with fluids, with means for controlling the dynamic velocity of the complete volume of fluids within the container. This is accomplished by moving the stagnant fluid from a plurality of regions through a plurality of thrust regions where the fluid is discharged to a plurality of regions of the dynamic surface of the same container. The dynamic surface accelerates the complete volume of fluid within the container to proximate the velocity produced by the layers of accelerated fluid from the stagnant regions through the thrust regions. A plurality of waterwheels properly distributed within the container, harvest the kinetic energy within the moving fluids, converting the energy to mechanical energy and transferring the torque created to other components that amplifies the designed revolutions per minutes (RPM) achieved within the container, to a designed RPM for the generation of green electric power.

2. This hydroelectric system for extracting green electric power by using a controlled environment within a large container filled with fluids, wherein to distinguish this green electric power system from prior claims, the system is identified as the Controlled Momentum Hydro-Electrical System (COMHES); wherein claim 1, can be accomplished by the incorporation in the COMHES, engineered designed embodiments of a plurality of mechanical devices and waterwheels.

3. This hydroelectric system for extracting green electric power by using a controlled environment within a large container filled with fluids, wherein to accomplish claim 1, another embodiment is incorporated, an enclosed water reservoir, generally, a main tank, identified as a Continuum Dynamics Fluids Tank, or CDFT, of metal or fiber/carbon composite or any other material determined as the interior surface of different dimensions, consistent with desired capacity load, laid out in a circular configuration, of varied dimensions according to each designed load capacity, containing the necessary water volume for the generation of electricity.

4. This hydroelectric system for extracting green electric power by using a controlled environment within a large container filled with fluids, wherein to accomplish claim 1, another embodiment is incorporated, after all the operational components have been installed, the structure will be encased by an engineered designed concrete reinforced construction.

5. This hydroelectric system for extracting green electric power by using a controlled environment within a large container filled with fluids, wherein to accomplish claim 1, in the interior floor base will house a plurality of wheel well mass embodiments to quarter a plurality of waterwheels herein identified as Hydro-Kinetic Transport Wheels, or HKT-Wheels.

6. This hydroelectric system for extracting green electric power by using a controlled environment within a large container filled with fluids, wherein to accomplish claim 1, another embodiment is incorporated, submersible HKT-Wheels of special designed, with dimensions of depth and width in accordance with the desired capacity load, equally separated within the CDFT, alternating the location of the installation of the wheel well mass embodiments on the sides of the CDFT. The HKT-Wheels will serve as the kinetic transformers to mechanical power.

7. This hydroelectric system for extracting green electric power by using a controlled environment within a large container filled with fluids, wherein to accomplish claim 1 and facilitate claim 4, another feature is incorporated, as it will be created by independent walls which will move into place at the same time the wheel is positioned inside the CDFT. The walls of each well wheel mass embodiments will not be affixed permanently to the structure of the CDFT, and will be moved into place together as a unit with the HKT-Wheels.

8. This hydroelectric system for extracting green electric power by using a controlled environment within a large container filled with fluids, wherein to accomplish claim 1 and facilitate claim 4, the depth portion of the well wheel mass embodiments will be determined by the size of the HKT-Wheels which will be in accordance with the designed capacity load. The well wheel mass embodiments will rest at the subfloor level of the CDFT. The cradle will enclose 51% of the propeller/wheel, with a clearance on each side and bottom of the HKT-Wheels consistent with the designed capacity loads.

9. This hydroelectric system for extracting green electric power by using a controlled environment within a large container filled with fluids, wherein to accomplish claim 1 and facilitate claim 4, another embodiment is incorporated, as the independent walls may necessitate to be positioned over rail tracks consistent with the size and weight of the designed load capacity. The rail system has multiple applications in the operation of the COMHES and it is conceived that all the operational devices will be mounted in rail car platforms to provide flexibility and speed to minimize the down time during maintenance operations.

10. This hydroelectric system for extracting green electric power by using a controlled environment within a large container filled with fluids, wherein to accomplish claim 1, the floor base of the fluid circulating within the CDFT shall be identified as the channel base level.

11. This hydroelectric system for extracting green electric power by using a controlled environment within a large container filled with fluids, wherein to accomplish claim 1 and facilitate claim 4, the center of each well wheel mass embodiments will follow the center of the HKT-Wheel, which will be defined by the HKT-Wheel main shaft(s), on which the HKT-Wheel is driven by the water velocity and collects the kinetic energy and transfers the mechanical energy for the creation of electrical power.

12. This hydroelectric system for extracting green electric power by using a controlled environment within a large container filled with fluids, wherein to accomplish claim 1 and facilitate claim 4, another embodiment is incorporated, the well wheel mass embodiments will have two special bearing mounts anchoring devices; structurally designed and positioned on each side of the well wheel mass embodiments, to hold the main shaft in place.

13. This hydroelectric system for extracting green electric power by using a controlled environment within a large container filled with fluids, wherein to accomplish claim 1 and facilitate claim 5, another embodiment is incorporated, a primary engineered main shaft.

14. This hydroelectric system for extracting green electric power by using a controlled environment within a large container filled with fluids, to accomplish claim 1 and facilitate claim 4 and claim 11 another embodiment is incorporated, an axel housing guide, a tube embodiment, installed imbedded into the concrete structure, below the floor channel base level of the CDFT. The axel housing guide will be designed to hold in place the shaft and to help support the weight load of the HKT-Wheel and shaft during the extreme dynamic forces exerted by the weight and velocity of the rotating water. The axel housing guide will include in the designed, a series of bearings, allowing for the ease insertion of the shaft and free rotation of the shaft during operation.

15. This hydroelectric system for extracting green electric power by using a controlled environment within a large container filled with fluids, to accomplish claim 1, another embodiment is incorporated, special designed steel doors, integral part of the structure of the CDFT, to allow access to the HKT-Wheel, at each location of the access openings, encased in a metal frame and the frame permanently attached to the CDFT, secured in a structural concrete with metal reinforcements. The door will be designed to open laterally along the frame, equipped with roller bearing, facilitating the movement of the heavy doors. The doors will open electronically by electrical, pneumatic or mechanical means. These doors will be water tight closing around the main shaft providing the water sealing requirement with rubberized male-female edges encircling a special housing around the main shaft which will be part of the fixed shaft guide. The steel doors, will allow access to the wheel to be removed from operation for maintenance, repairs or replacement without stopping the operating circulating fluid.

16. This hydroelectric system for extracting green electric power by using a controlled environment within a large container filled with fluids, to accomplish claim 1, another embodiment is incorporated, a maintenance chamber also equipped with special designed steel doors, integral part of the structure, as the maintenance/repair/or replacement station for the HKT-Wheels.

17. This hydroelectric system for extracting green electric power by using a controlled environment within a large container filled with fluids, to accomplish claim 1, another embodiment is incorporated, a electromagnetic generator that will use the torque input speed of the main drive shaft to generate an independent energy supply for primary and ancillary equipment such as the turbo pumps.

18. This hydroelectric system for extracting green electric power by using a controlled environment within a large container filled with fluids, to accomplish claim 1, another embodiment is incorporated, step up gears of single, split or multiple operating shafts for the generation of electric power.

19. This hydroelectric system for extracting green electric power by using a controlled environment within a large container filled with fluids, to accomplish claim 1, another embodiment is incorporated, a reserve holding tank to replenish the water that through friction and evaporation could be lost. The location of the tank will be underground, at the center of the COMHES, with connecting lines to the CDFT which will maintain the operational water level and each maintenance vault for filling and dewatering during the maintenance of the KTT-Wheels.

20. This hydroelectric system for extracting green electric power by using a controlled environment within a large container filled with fluids, to accomplish claim 1, there are several significant components associated with electrical distribution, ancillary devices, monitoring, security which will be irrelevant to mention because are germane to the existing generating plants and will be used in the COMHES, but all devices and components to be used will have 0% impact to the environment.

21. This hydroelectric system for extracting green electric power by using a controlled environment within a large container filled with fluids, to accomplish claim 1, a structural designed building to house the COMHES, maintenance, distribution equipment, and staff;

22. The present invention is not limited to the embodiments described above, but it extends to all modifications or variants obvious to a person skilled in the art.
